(19) United States
(12) Patent Application Publication
(10) Pub. No.: US 2008/0035557 A1
(43) Pub. Date: Feb. 14, 2008

(54) Polymer-coated inorganic membrane for separating aromatic and aliphatic compounds

(76) Inventors: Randall D. Partridge, Califon, NJ (US); Dennis G. Pefiffer, Annandale, NJ (US); David C. Dalrymple, Bloomsbury, NJ (US); Walter Weissman, Basking Ridge, NJ (US)

Correspondence Address: ExxonMobil Research and Engineering Company, P.O. Box 900, Annandale, NJ, 08801-0900, US

(21) Appl. No.: 11/890,634

(22) Filed: Aug. 7, 2007

Related U.S. Application Data
(60) Provisional application No. 60/836,319, filed on Aug. 8, 2006.

(51) Int. Cl. B01D 69/12; B01D 67/00; B01D 71/64; B01D 69/04

(52) U.S. Cl. 210/500.23; 210/500.26; 210/500.27; 210/500.39; 427/245

(57) ABSTRACT

A membrane composition comprising an inorganic substrate which has a coating of an associating polymer. The membrane composition includes an inorganic substrate selected from the group consisting of a porous silica hollow tube, an alumina hollow tube and a ceramic monolith.

This application claims the benefit of U.S. Provisional Application No. 60/836,319 filed Aug. 8, 2006.

### BACKGROUND OF THE INVENTION

The present invention is a membrane system and process for separating aromatics from aliphatic compounds. In particular, the membrane is an inorganic substrate, which has a coating of an associating polymer.

There is substantial need to enhance the performance, including selectivity and flux (and environmental safety), manufacturability and durability of membrane/module units that are used to separate aromatic and aliphatic compounds from hydrocarbon-based feed streams. Prior art units such as spiral wound modules involve a number of complex steps to manufacture with a large amount of human intervention. As a result, these are costly to manufacture and quality control is a major problem.

The use of membranes to separate aromatics from saturates has long been pursued by both industrial and scientific establishments. Spiral wound modules have been a main choice to-date. As a result these are costly to manufacture, and quality control is a problem. For example, they have been found to be highly prone to leakage in operation. Sealing is accomplished by an operator adding a multitude of glue lines. This takes time in manufacture and is prone to variability in sealing control.

The present invention includes a new associating polymer solution to form a chemically crosslinked polymer/inorganic membrane system. The invention further including the use of associating polymer formulations that facilitate coating of exceptionally thin films on porous ceramic substrates, leading to substantial membrane performance gains. This assembly lends itself to highly automated manufacture with excellent quality control. These membranes can be used in numerous applications where efficient and effective separation of aromatics and aliphatics are required, e.g., on-board separation of fuels in automobiles and trucks, refinery and other downstream operations, upstream applications, and the like.

### SUMMARY OF THE INVENTION

The present invention pertains to a membrane system and process for separating aromatic and aliphatic compounds. More particularly, the present invention pertains to a membrane system comprising a porous inorganic substrate (such as alumina for example), at least a portion of which is coated with an organic, polymeric membrane. The membrane system is particularly well suited for separating hydrocarbon species such as separating aromatics from aliphatics.

The substrate support material may include a porous silica or alumina hollow tube or ceramic monolith among other inorganic substrates. In one embodiment, a polyimide material is dip coated from solution onto the outer surface of the tube, dried, and cured. Alternatively, the polymer solution is coated onto the inner surface(s) of a ceramic monolith through the use of a vacuum. In a preferred embodiment the polymer component of the membrane composition includes an imide-based hard segment and a soft segment containing an aliphatic polyester. Mixtures of various soft segment compositions are also included in this invention. Another aspect of this invention is the use of various mixtures of diamines and dianhydrides in preparation of the polymer. Another novel aspect of this invention is the use of the polyamic acid form of the polyimide to solution coat the above-described substrates. These polyamic acid based formulations are further described as associating polymers. The associating functionalities of these polymers are understood to facilitate uniform deposition of the polymer material to produce uniform coatings, suitable for use in membrane separations of hydrocarbon species. The invention includes the use of associating polymer structures in general, and polyamic acid type associating polymers, in particular. The present invention also includes the various combinations of diamines, dianhydrides and difunctional soft segments incorporated into the copolymer structure to form a wide variety of multi-compositional polyamic acids that can be coated, dried and cured on the surface(s) of the inorganic membrane substrate. Another embodiment of the invention employs different zones in the membrane using different membrane compositions tailored to optimize membrane permeation and selectivity that may be useful for varied feed composition(s). The present structure has the ability to operate with a mixed vapor/liquid feed mixture and with the flow dynamics controlled so that the liquid film coats the membrane, thereby maximizing the permeation of aromatics relative to lower boiling range molecules.

### DETAILED DESCRIPTION OF THE DRAWINGS

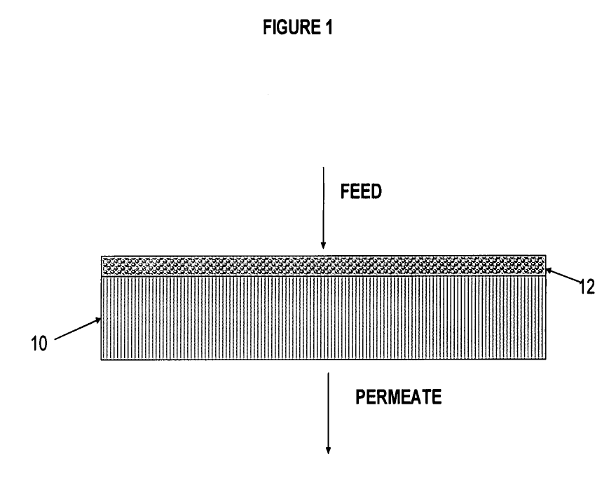

FIG. 1 illustrates a simple embodiment of the present invention.

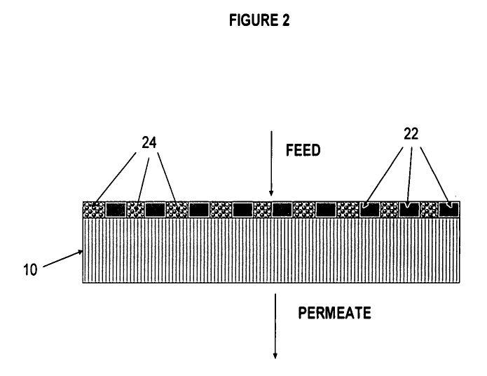

FIG. 2 illustrates a simple embodiment of the membrane system of the present invention having hard and soft segments.

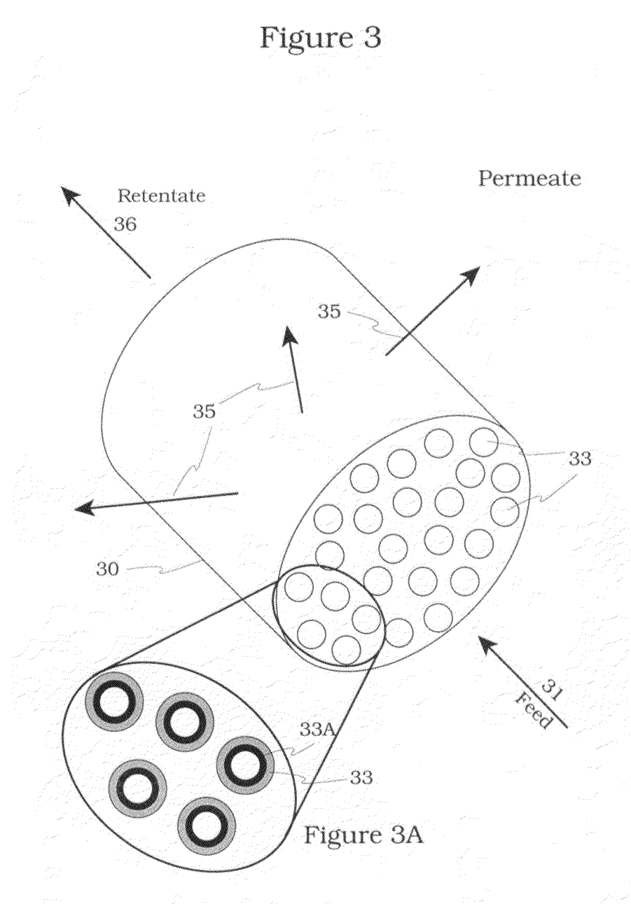

FIG. 3 illustrates the present invention using a tubular inorganic substrate.

### DETAILED DESCRIPTION OF THE PREFERRED EMBODIMENTS

The present invention is directed to a membrane system that has enhanced performance, including selectivity and flux (and environmental safety), manufacturabilty and durability of membrane/module units that are particularly suitable for separating aromatic and aliphatic compounds from hydrocarbon-based feed streams.

This invention includes a new associating polymer/porous inorganic substrate membrane system. The substrate material in this construction may comprise porous silica or alumina, and may be configured as a hollow tube or ceramic monolith, among other inorganic substrate configurations.

In one instance, the polyamic acid material is dip coated from solution onto the outer surface of the inorganic substrate, dried, and cured. Alternatively, the polymer solution is coated onto the inner surface of a ceramic monolith through the use of a vacuum. The membrane-coated monolith is dried and cured. The composition of the resulting polyimide layer incorporates multiple segments, referred to herein as “hard segments” and “soft segments.” Hard segment, as used herein, means a segment of the polymer that has a glass transition temperature greater than approximately 100° C. Soft segment, as used herein, means a polymer segment that is a relatively lower modulus/elastomeric segment (relative to the hard segment) and has a glass transition temperature less than approximately 100° C. The composition is formed into a polymer configuration, which incorporates the previously described hard and soft segments in an alternating, multiblock structure. In particular, the polymer composition contains an imide-based hard segment, and a soft segment containing an aliphatic polyester. For example, the polyimide segment contains pyromellitic dianhydride (PMDA) and 4,4′-methylene bis(2-chloroaniline) [MOCA], i.e., a dianhydride and a diamine, respectively. The soft segment is polyadipate, a polysuccinate, a polymalonate, a polyoxalate, and a polyglutarate among others. Mixtures of various soft segment compositions among the hard segment compositions are one of the novel aspects of this invention. Another novel aspect of this invention is the use of various mixtures of diamines and dianhydrides reagents in the preparation of these segments. These segments, separately, are known to those versed in the art, as exemplified in U.S. Pat. Nos. 4,990,275 and 5,670,052. Another novel aspect of this invention is the use of polyamic acid as a precursor to form the polyimide. These polyamic acids are best described as associating polymers as described herein.

In an alternative embodiment, the polyimide segment of the associating polymer comprises aminaphenyl disulfide, or “APD,” as more fully described in a co-pending U.S. patent application Ser. No. ______ filed ______ concurrently entitled “Membrane for Separating Aromatic and Aliphatic Compounds.”

The associating functionalities are understood to substantially facilitate deposition of the membrane polymer. The invention is not limited to the use of polyamic acid-type associating polymers, but to the use of associating polymer structures in general. These families of copolymers, for example, include functionalities possessing hydrogen-bonding interactions (e.g., polyamic acids), dipolar interactions, hydrophobic, and ionic interactions. Membrane formation, performance, and utility are directly related to the structural components comprising the copolymer structure. Associating polymers provide an effective molecular weight higher then the molecular weight of the individual polymer chains. In a preferred embodiment, the associating polymers can be formed in a facile manner under anhydrous conditions, which typically allow for formation of individual polymer chains of higher molecular weight. Higher molecular weight polymers are desirable in order to produce coherent, uniform, and thin polymer membranes. Another aspect of this invention is that various combinations of diamines, dianhydrides and difunctional soft segments can be incorporated into the copolymer structure to form a wide variety of multi-compositional polyamic acids that can be coated, dried and cured on the surface of the porous inorganic substrate. Another aspect of this invention is the ability to effectively and efficiently coat the inner and/or outer surfaces of porous inorganic substrates such as a tubular ceramic or monolith, for example. Different polyimide structures or a wide variety of alternative copolymer structures can be coated on the inner and outer surfaces of the inorganic support. Assembly by these methodologies lends itself to highly automated manufacture with excellent quality control.

In completing the synthesis of polymer, the polymer is crosslinked by using a crosslinking agent such as a diepoxide for example. In one embodiment, the crosslinking reaction is understood to occur among pendant carboxylic acid group adjacent to the ester linkage located between polyimide hard segments and polyester soft segments. Although not fully understood, these reactions are believed to include reactions of the diepoxide with the hydroxyl groups at the interface with the inorganic substrate.

Another aspect of the invention is the ability to create different zones along the length of the membrane using different membrane compositions tailored to the changing feed composition to optimize membrane permeation and selectivity. These membranes can be used in numerous applications where efficient and effective separation of aromatics and aliphatics are required, e.g., on-board separation of fuels in automobiles and trucks, refinery and other downstream operations, upstream applications, and the like.

Referring to FIG. 1, there is shown a polymer coated inorganic porous substrate membrane system in accordance with the present invention. A substrate 10, here shown as disposed under layer 12, comprises a porous material such as alumina, for example. Substrate 10 is characterized as comprising a porous material, suitable for physical support of the polymeric membrane detailed hereinafter. The porosity of the substrate is selected based upon the feed materials that it will be used for separating. That is, the pore size of the substrate is selected to provide little or no impedance to the permeation of the materials that are intended to be the permeate of the overall membrane system. Suitable porous substrates include alumina, silica, titania, zirconia and the like. In a preferred embodiment, porous substrate 10 comprises an inorganic ceramic material such as silica, alumina, or a combination thereof. It is also preferred that the ceramic substrate is substantially permeable to hydrocarbon liquid such as gasoline, diesel, and naphtha for example. It is also preferred that the pore size distribution is asymmetric in structure, e.g., a smaller pore size coating is supported on a larger pore size inorganic structure.

To facilitate the formation of the polymeric membrane 12, the average surface porosity of the inorganic substrate is selected to be approximately equal to or less than the size of the associating polymer aggregate.

Not wanting to be held to any particular theory, to further facilitate a physical and/or chemical bonding of the polymeric coating to the porous substrate the surface should be sufficiently polar as to ensure wetability of the polymer solution to the inorganic substrate surface.

Although shown in FIG. 1 as a planer substrate for ease of illustration, this invention teaches the use of multiple configurations of the porous substrate. Ceramic tubes and ceramic honeycomb materials are well suited configurations for the porous substrate (10) of the membrane system of the present invention.

The polymer comprising the polymeric membrane layer (12) is an associating polymer. By associating polymer, we mean polymers and copolymers having mutual self attractions due to specific secondary interactions such as hydrogen bonding interactions, polar and di-polar interactions, as well as ionic, acid-base, coordination bonding, and hydrophobic interactions. Suitable associating polymers include polyamic acid polymers and copolymers.

The polymer membrane layer (12) may be formed on the porous substrate (10) by conventional coating techniques. However, in a preferred embodiment, ultrasonic vibration is applied to at least the surface area of the porous substrate to facilitate a uniform coating, which in turn permits a thinner and uniform, yet continuous polymer membrane to be formed. The application of ultrasonic vibration to the coating process is understood to facilitate membrane wetting of the substrate as well as reducing air bubbles entrained in the polymer.

Referring to FIG. 2, another embodiment of the present invention employs a polymer comprising at least two segments, illustrated in the figure. A first or “hard segment” (22) is characterized as having a glass transition temperature greater than about 100° C. The hard segments (22) are preferably distributed along the polymer structure in an alternating fashion as illustrated in the figure. The hard segments (22) comprise a polyimide, preferably imide based aliphatic polyester. Suitable hard segments (22) may comprise pyromellitic dianhydride (“PMDA”), 4,4′-methylene bis(2-chloroaniline).

A “soft segment” (24) is characterized as having a glass transition temperature less than about 100° C. The soft segments are preferably distributed in alternating fashion, as illustrated in the figure. The soft segments (24) generally comprise an aliphatic polyester, preferably having a lower modulus than the hard segments (22). Suitable soft segments (24) comprise polyadipates, polysuccinates, polymalonates, polyoxalates, or polygluterates, for example. Not wanting to be held to any particular theory, it is believed that the “hard segment” is essentially impermeable to permeate diffusion believed attributable to increased rigidity induced by the chemical crosslinks. The “soft segments” composition is believed to predominate the level of permeate solubility and diffusion resulting in the observed high selectivity and flux membrane characteristics of the membrane of the present invention. Stated otherwise, the feed preferentially diffuse through the “soft segments.” The separation system may thereby be tailored to preferentially permeate certain feed constituents by controlling the amounts and/or locations of soft versus hard membrane segments.

The examples presented below exemplify the subject matter for this invention.

### EXAMPLE 1

Diepoxide crosslinked/esterified polyimide-aliphatic polyester copolymers were synthesized from an oligomeric aliphatic polyester diol, an anhydride, a diamine, and a diepoxide or mixtures thereof. To illustrate the synthesis and composition of the new copolymers, a diepoxy n-octane crosslinked/esterified polyimide-polyadipate copolymer (diepoxy n-octane polyethylene imide, [PEI]) membrane was used as an example. In the synthesis, 5 g (0.005 moles) of a 1000 g/mole polyethylene adipate diol (PEA) was reacted with 2.18 g (0.01 moles) of pyromellitic dianhydride (PMDA) to make a prepolymer in the end-capping step (reaction conditions: 165° C./6.5 hours). 25 g of dimethylformamide (DMF) was subsequently added. The temperature was decreased to 70° C. The prepolymer was dissolved in a suitable solvent such as dimethylformamide. 1.34 g (0.005 moles) of 4,4′ methylenebis(2-chloroaniline) (MOCA) was subsequently added (dissolved in 5 g DMF). In the DMF solution, one mole of the prepolymer reacts with one mole of MOCA to make a copolymer containing polyamic acid hard segment and PEA soft segment in the chain-extension step. An additional 91.0 g of DMF was added. Subsequently, 121.0 g acetone was added to prevent gelling. The solution was stirred for 1.5 hours (70° C.). The solution was then cooled to room temperature under continual stirring conditions. 1,2,7,8-diepoxy n-octane (designated DENO) (1.42 g-0.01 moles) was subsequently added to the copolymer-DMF solution at a diepoxide/PEA molar ratio of 2. At this point the copolymer concentration is 4.0 wt %. The new copolymer membrane was prepared by solution coating (e.g., dip coating or using a vacuum to draw the polymer solution into the porous, inorganic substrate) onto a porous inorganic tubular support (e.g., porous silica, porous titania or porous alumina). Membrane thickness was adjusted by changing the polymer concentration and rheology. In addition, solution temperature, solvent composition and quality, pressure drop across the porous substrate and immersion time may be varied to tailor membrane structure and performance. The membrane was initially dried at a suitable temperature (e.g., room temperature) to remove most of the solvent (i.e., solvent evaporation), and curing occurred (i.e., chemical crosslinking/imidization reaction conditions: 150° C. for 1.5 hours) with the reaction of diepoxide with pendent carboxylic acid groups. In the initial drying step, DMF was evaporated from the membrane in a box purged with nitrogen gas at room temperature for approximately 12 hours. The membrane is composed of a crosslinked/esterified polyimide-polyadipate copolymer. The curing step converts the polyamide ester hard segment to the polyimide hard segment via the imide ring closure.

In the synthesis with PEA, PMDA, MOCA and diepoxide at a molar ratio of 1/2/1/2, the crosslinking reaction occurs among pendent carboxylic acid groups adjacent to the ester linkages located between polyimide hard segments and polyester soft segments. Though not fully understood, it is believed that the crosslinking agent crosslinks the polymer to the surface of the inorganic substrate by analygous reaction with the surface's hydroxyl groups. The degree of crosslinking can be varied by controlling the concentration of diepoxide incorporated into the multiblock structure. In addition, the “soft” segment denoted as PEA (1000 g/mole average molecular weight) can be replaced with PEA (2000 or 3000 g/mole average molecular weight), for example.

A portion of the above synthesized copolymer solution was diluted with equal amounts of dimethylformamide and acetone (50/50 by weight) to reduce the copolymer concentration to 1.0 wt %. The diluted solution was vigorously stirred at room temperature to insure solution consistency and uniformity.

### EXAMPLE 2

In this example, the porous, inorganic ceramic monolith support included a silica topcoat. A nominal 0.005 micron pore size silica monolith produced by CeraMem Corp. (Waltham, Mass.)—designated model LM-005-5 (S/N AG 1367) is used in this example. The coating procedure consisted of filling the inside of the monolith via gravity feed with the PEI copolymer solution (C<C*; C=1.0 wt %, where C* is chain overlap concentration) described in Example 1. The dilute solution was subsequently drawn into the interior surface of the monolith with the use of a vacuum positioned on the back side of the monolith. The monolith was placed in a stainless steel container so as to effectively and efficiently pull a vacuum as well as contain the dilute unused copolymer solution. During the coating procedure a vibrating ultrasonic probe was positioned to help ensure coating uniformity and thinness. The diluted solution penetrated and wet substantially the entire monolith structure; however, the associating copolymer component was retained at the monolith surface/solution interface. A microscopic examination of the final membrane coated monolith product confirmed this result.

### EXAMPLE 3

A inorganic silica monolith support was coated according to the following procedure.

A CeraMem, Inc. monolith test module, 1 foot long×1 inch diameter, having 0.005 micron porosity silica coated 2 mm×2 mm channels, was coated with a dilute solution of the PEI polymer precursor, i.e. polyamic acid. 130.7 g of a 2 wt % polymer solution was placed in separatory funnel, gravity fed into the monolith interior channels, and subsequently “pulled” into the membrane monolith structure via a vacuum on the back side of the module. A sonicator probe was then used to dislodge/move any trapped air and/or solvent bubbles in the surface structure of the monolith. The sonicator probe was placed against the metal housing and turned on for approximately 30 seconds. The following sonicator settings were used: output—level 4; %, duty—40%. Laboratory vacuum was then applied on the backside of the ceramic monolith. Vacuum was applied until all of the copolymer solution had been used from the separatory funnel. The unused solution was trapped in a vacuum flask. Recovered solution weighted 31.4 g. Solutions recovered from the vacuum flask and from the monolith amounted to 82.0 g. Based on the foregoing, the unrecovered solution from the flask and the monolith amounted to 48.7 g. The monolith was subsequently removed from the metal housing and allowed to drain any remaining solution by being held vertically with a paper absorbent stuffed at the bottom of the monolith. The paper absorbent wicked away excess any excess copolymer solution. The monolith was placed vertically in a nitrogen gas box for drying over night. The monolith was further dried at 120° C. for one hour under a flowing of nitrogen gas and then the cross-linking curing step was performed at 150° C. for 1.5 hours again under a flow of nitrogen gas. The weight of monolith prior to membrane deposition was 308.9 g. After membrane deposition the monolith weight was 309.4 g. The coated monolith was leaked tested via a conventional vacuum drop test, i.e. 85 kPa vacuum to a 40 kPa vacuum over a time period of 22 mins and 85 kPa vacuum to a 15 kPa vacuum over a time period of 48 mins. An approximately 3 micron polymer coating was deposited as determined by conventional scanning electron microscopy (SEM).

This polyimide composition containing the PEA soft segments was coated on other ceramic monoliths, i.e., alumina and titania substrates. This specific coating procedure produced essentially equivalent results in terms of membrane thinness, coherency, excellent adhesion of membrane to the ceramic surface, and robustness under high temperature and in the presence of high concentration of organic liquids, e.g., gasoline.

### EXAMPLE 4

Scanning electron microscopy (SEM) and optical microscopy were used to determine the uniformity, coherency, as well as thickness of the membranes produced via the procedure described above. Micrographs identified that the polymer was substantially located on the surface of the ceramic monolith. In addition, the micrographs illustrate that the membranes are highly coherent, pinhole free, and thin.

### EXAMPLE 5

The membrane sample of Example 1 was evaluated for integrity and performance. First, the membrane element was tested for its ability to hold vacuum. Vacuum was applied to the outside of the mounted element at a pressure of 19 kPa absolute and isolated, with the channels of the element open to ambient atmospheric pressure and temperature. A modest loss of vacuum was observed over 10 minutes to 41 kPa, corresponding to 2.2 kPa/min. The membrane channels were then filled with a 50/50 wt/wt mixture of toluene and n-heptane pressurized to 450 kPag and vacuum reapplied. The element was isolated on both the feed channel and vacuum sides. Vacuum integrity was tested, with minimal pressure gain from 18.7 to 21.8 kPa over 10 minutes for 0.3 kPa/min. Pressure integrity was also tested with nominal pressure decrease from 400 to 350 kPag over 10 minutes or only 5 kPa/min. The 50/50 wt/wt toluene/n-heptane feed flow through the membrane element channels was established nominally at 1.0 g/s, with an inlet pressure of about 457 kpag and inlet temperature of 167° C. Vacuum was maintained at 7 kPa on the outside of the membrane element resulting in a permeate flux of 0.148 g/s. A temperature drop of 37° C. to 130° C. along the length of membrane element was observed, consistent with the expected pervaporation process. Chromatographic analysis of the permeate obtained showed toluene increased to 80.3% from 50% in the feed for an aromatic selectivity of 4.0. Aromatic selectivity means (% aromatics in permeate/% non-aromatics in permeate)/(% aromatics in feed/% non-aromatics in feed). The following table summarizes the finding.

TABLE 1

| | PEI-PEA1000-DENO/0.005 um |
|---|---|
| Membrane Description | SiO2/SiC Ceramem |
| Area, m2 | 0.11 |
| gms of polymer coated | 0.5 |
| Estimated Thickness, microns | 3 |
| Vac Drop from 10 kPa, dry membrane | 2.2 |
| kPa/min 10 min | |
| Vac Drop from 10 kPa, wet membrane | 0.31 |
| kPa/min 10 min | |
| Pressure Drop from 350 kPag, wet | 5 |
| kPa/min 10 min | |
| Feed Rate, g/s | 1.018 |
| Pressure, kPaa | 557.2 |
| Temperature Average ° C. | 148 |
| Permeate Pressure, kPa | 7 |
| Permeate Rate g/s | 0.148 |
| Permeate Density g/cc | 0.8167 |
| Permeate Aromatic wt/wt | 0.803 |
| Flux, g/m2-sec Uncorrected for T | 1.3 |
| Flux-Thickness, g micron/m2-sec | 3.9 |
| Aromatic Selectivity at yield, Retentate | 4.0 |

The above described associating polymer, and the physical and/or chemical bonding believed to occur of the polymer to the inorganic substrate surface, results in a strongly adherent polymeric layer. This novel membrane and the methods taught herein for forming the polymer on the porous substrate, are well suited to alternative configurations of the porous membrane. FIG. 3, for example, illustrates an alternative embodiment using a tubular inorganic substrate. Referring to the figure, feed (31) is provided to a plurality of channels (33) within the porous inorganic substrate (30) which may comprise silica or alumina, for example. The surface(s) of the channels (33) may, in a preferred embodiment, comprise a porous inorganic material whose porosity differs from the bulk porosity of substrate (30). Most preferably, the surface porosity of the channels (33) is less than or about equal to the aggregate polymer size of the associating polymer. As illustrated in exploded view 3A, channels (33) have a surface region (33A) that may be formed by wash coating the interior surfaces of substrate (30)'s channels (33) to form a silica topcoat, for example.

The channels (33), with optimal surface region (33A) are coated with an associating polymer layer (34), such as that described in Example 1, to form the membrane system of the present invention.

In this exemplified configuration, permeate from the membrane system may be extracted radially as illustrated at (35), and retentate exiting axially as (36).

What is claimed is:

1. A membrane for separating aromatic and aliphatic compounds comprising a porous inorganic substrate, which has a coating of an associating polymer.

2. The membrane of claim 1 wherein said porous inorganic substrate comprises alumina, silica, titania, zirconia or a combination thereof.

3. The membrane of claim 2 wherein the inorganic substrate is further characterized as having porosity to intended permeate of the membrane greater than porosity of the polymer coating.

4. The membrane of claim 2 wherein the associating polymer coating has an aggregate polymer size and the inorganic substrate has an average surface porosity of less than or about equal to the aggregate polymer size.

5. The membrane of claim 1 wherein said associating polymer comprises a polyimide acid polymer or copolymer.

6. The membrane of claim 5 wherein said associating polymer comprises at least one hard segment and at least one soft segment.

7. The membrane of claim 6 wherein said soft segment has a glass transition temperature of less than about 100° C. and the hard segment has a glass transition temperature above about 100° C.

8. The membrane of claim 7 wherein the soft segments preferentially permeate constituents of a feed compound relative to the hard segments.

9. The membrane of claim 6 wherein the hard segments comprise a polyimide.

10. The membrane of claim 9 wherein the soft segments comprise an aliphatic polyester.

11. The membrane of claim 10 wherein the hard segments comprise PMDA.

12. The membrane of claim 6 wherein said soft segments comprise polyadipates, polysuccinates, polymalonates, polyoxalates, polygluterates, or a combination thereof.

13. The membrane of claim 6 wherein the porous substrate comprises a ceramic monolith or a hollow tube.

14. The membrane of claim 4 wherein said porous inorganic substrate is further characterized as having a surface region porosity of less than or about equal to the aggregate polymer size and a porosity greater than the aggregate polymer size away from the surface region.

15. A method for making membrane system for separating hydrocarbon containing feeds comprising:
a. supplying an inorganic porous substrate, and
b. coating a surface region of the porous substrate with an associating polymer.
